(19) United States
(12) Patent Application Publication
(10) Pub. No.: US 2007/0198271 A1
(43) Pub. Date: Aug. 23, 2007

(54) Method for training a user of speech recognition software

(76) Inventor: Dana Abramson, Victor, NY (US)

Correspondence Address: JAECKLE FLEISCHMANN & MUGEL, LLP, 190 Linden Oaks, ROCHESTER, NY, 14625-2812, US

(21) Appl. No.: 11/360,892

(22) Filed: Feb. 23, 2006

(51) Int. Cl. G10L 21/00

(52) U.S. Cl. 704/275

(57) ABSTRACT

A method of training a user in the proper use of speech recognition software includes instructing the user how to properly pause between commands and dictation.

### BACKGROUND OF THE INVENTION

The present invention relates generally to speech recognition software and, more particularly relates to a novel training methodology for greatly enhancing a new user's successful implementation of the speech recognition software.

### SUMMARY OF THE INVENTION

The present invention comprises a method for training a person how to use speech recognition software such as Dragon Naturally Speaking software by Nuance, Inc. While some people successfully learn the proper use of the software using only the user's manual that comes packaged with the software, there are still many people that are unable to successfully learn the proper use of the software on their own. These people become frustrated in that the tool they had hoped would increase their productivity has instead had the exact opposite effect. These people are quick to abandon the software and perform the same task either manually by typing or by dictation for later transcription by an assistant. The present invention offers a novel method of teaching a user how to successfully learn the proper use of speech recognition software without becoming frustrated by the repeated, time-consuming errors which are typical of many users trying to learn how to use speech recognition software on their own with (or without) the aid of the software manual.

The present invention provides a method of training a user how to use speech recognition software comprising the steps of:
a) instructing a user to dictate into a microphone of a computer running the speech recognition software one or more sentences provided on paper to the user, the software programmed to convert the dictation of the user into digital text appearing on a monitor of the computer;
b) instructing the user to speak a series of predetermined commands into said microphone.
c) instructing the user to pause for between about 1 and 3 seconds and observing to ensure that the requested command was accomplished; and
d) instructing the user to repeat steps b) and c) until the user has learned to effectively pause between commands.

In a further aspect of the invention, the trainer instructs a user not to guess commands. This is because the spoken words which are not commands are interpreted as dictation or an alternate instruction. Users who guess commands and get them wrong become quickly frustrated because they do not see on the screen what they thought they had spoken. This user does not understand the computer interpreted the word or phrase as dictation or an alternate instruction. As a result of this frustrating experience, the user is likely to abandon further attempts to learn how to use the software correctly. The present inventor has found that if a user is instead instructed (and learns) not to guess commands, this particular issue is not raised, the user does not become frustrated, and the chance for successful, ongoing use of the software is increased.

In a further aspect, the user is provided with an email memo each day following the user's initial training session for a predetermined number of days (preferably about five (5) days), at least one (but preferably all) of the email memos including a request that the user reply to the message using the speech recognition software. This greatly improves the user's chance of successfully using the software while at the same time showing the instructor any problems the user is having with the software.

### BRIEF DESCRIPTION OF THE DRAWINGS

FIG. 1 is a flow diagram showing the basic process steps of an embodiment of the present invention; and

FIG. 2 is a flow diagram showing another aspect of the invention.

### DETAIL DESCRIPTION

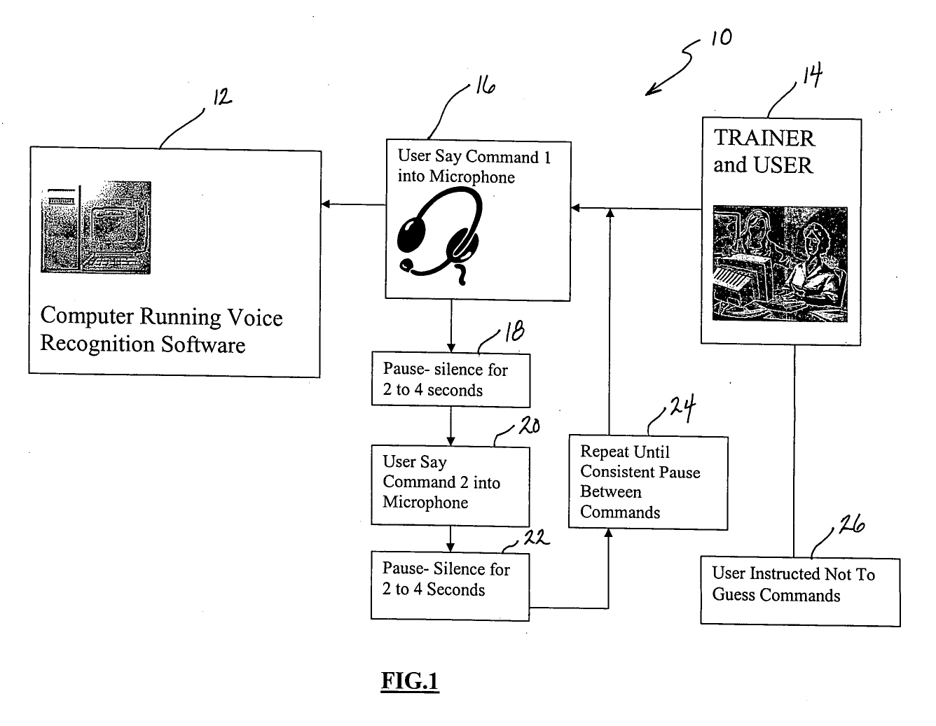

Referring to FIG. 1, a basic process flow chart 10 is shown including a computer 12 which is running a speech recognition software program such as Dragon Naturally Speaking, for example. A trainer and user as shown in block 14 sit together and the trainer instructs the user to follow certain steps in order to learn how to quickly and effectively learn the proper use of the speech recognition software. The user is provided with a microphone as at block 16 into which they are instructed to speak. The trainer first provides the user with a piece of paper having one or more sentences printed thereon. The user is instructed to dictate the sentences into the microphone. The speech recognition software converts the dictation into digital text appearing on the monitor of the computer. The trainer then provides the user with a set of commands which the software has been programmed to recognize as commands. A command is a word or phrase that, according to the software programming, carries out a specific task.

Examples of common dictation and editing commands include the following:

| SAY | FOR |
|---|---|
| PERIOD | . |
| COMMA | , |
| OPEN QUOTE | “ |
| QUESTION MARK | ? |
| OPEN PAREN | ( |
| MOVE TO BOTTOM | Moves cursor to bottom of page |
| SELECT word(s) | Highlights text that needs editing |
| CAP THAT | Capitalizes the highlighted word |

The trainer at block 14 instructs the user to speak commands into the microphone while observing how the software carries out the various commands on the text on the monitor screen. The trainer teaches the user the pause technique by instructing the user to pause for between about 1 and 3 seconds between each command while observing the monitor to ensure that the spoken command was accomplished as at blocks 18 and 22. The instructor then instructs the user to repeat this exercise until the user has learned to effectively pause between commands as at block 24. A typical user may need about five (5) minutes to correctly learn this pause technique.

In a further aspect of the invention, the trainer instructs a user not to guess commands as at block 26. This is because spoken words which are not commands are interpreted by the software as dictation or an alternate instruction. Users who guess commands and get them wrong become quickly frustrated because they do not see on the screen what they thought they had spoken. This user does not understand the computer interpreted the word or phrase as dictation or alternate instruction. As a result of this frustrating experience, the user is likely to abandon further attempts to learn how to use the software correctly. The present inventor has found that if a user is instead instructed (and learns) not to guess commands, this particular issue is not raised, the user does not become frustrated, and the chance for successful, ongoing use of the software is increased.

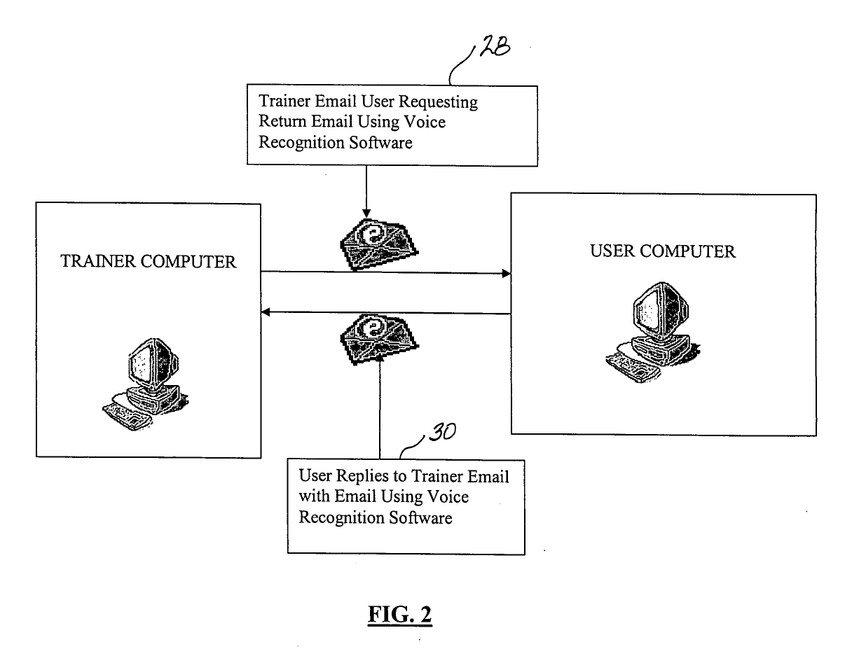

In a further aspect of the invention as shown in FIG. 2, the user is provided with an email memo each day following the user's initial training session for a predetermined number of days, (preferably about five (5) days) at least one (but preferably all) of the email memos including a request that the user reply to the message using the speech recognition software. This is illustrated at blocks 28 and 30. This greatly improves the user's chance of successfully using the software while at the same time showing the instructor any problems the user is having with the software.

What is claimed is:

1. A method of training a user how to use speech recognition software comprising the steps of:
a) instructing a user to dictate into a microphone of a computer running the speech recognition software one or more sentences provided on paper to the user, the software programmed to convert the dictation of the user into digital text appearing on a monitor of the computer;
b) instructing the user to speak a series of predetermined commands into said microphone while observing the monitor to ensure the spoken commands are being accomplished;
c) instructing the user to pause for between about 1 and 3 seconds between spoken commands in step b); and
d) instructing the user to repeat steps b) and c) until the user has learned to effectively pause between commands.

2. The method of claim 1, and further comprising the step of:
e) instructing the user not to guess at commands

3. The method of claim 1 and further comprising the step of sending an email memo each day to the user following the user's initial training session for a predetermined number of days, at least one of the email memos including a request that the user reply to the message using the speech recognition software.

4. The method of claim 3 wherein email memos are sent to the user for five (5) days and each email memo requests the user to reply using the speech recognition software.
